(19) United States
(12) Patent Application Publication
(10) Pub. No.: US 2025/0371655 A1
(43) Pub. Date: Dec. 4, 2025

(54) Method for Generating a Composite Circular Image or Circular Ring Image

(71) Applicant: Albert Orglmeister, Wiesbaden (DE)

(72) Inventor: Albert Orglmeister, Wiesbaden (DE)

(21) Appl. No.: 18/867,460

(22) PCT Filed: May 10, 2023
(86) PCT No.: PCT/EP2023/062395

§ 371 Date: Nov. 20, 2024

(30) Foreign Application Priority Data
May 29, 2022 (DE) 10 2022 113 479.2

(51) Int. Cl. G06T 3/4038; G06T 1/00

(52) U.S. Cl. CPC G06T 3/4038; G06T 1/0014; G06T 2207/10004

(57) ABSTRACT

The invention relates to a method for generating a composite circular image (12) or circular ring image (13) on a screen (7) using image data from a rotating camera (2) with a certain orientation to the axis of rotation (33), in which method the image data are processed at an image-processing device (10), the camera (2) supplying a rectangular image (14) which is longitudinally delimited by a start line (15) and an end line (16), and the image (14) being modified in such a way—that the start line (15) forms a circular image center point (22) and the end line (16) forms an outer radius of a circular segment image (24) when the camera (2) is oriented in such a way that the start line (15) intersects the axis of rotation (33), a plurality of circular segment images (24) being sequentially assembled to produce a circular image (12), or—that the start line (15) forms an inner radius and the end line forms an outer radius of a circular sector image (35) when the camera (2) is oriented in such a way that the start line (15) is offset by a positive angle to the axis of rotation (33), a plurality of circular sector images (35) being sequentially assembled to produce a circular ring image (13), —wherein the image-processing device (10) concentrically aligns at least one generated circular image (12) with at least one generated circular ring image (13) and displays images (14), that are captured successively by means of the camera (2), in combined fashion on the screen (7).

### CROSS REFERENCE TO RELATED APPLICATIONS

This application is the U.S. national stage of International Application No. PCT/EP2023/062395, filed on 2023 May 10. The international application claims the priority of DE 102022113479.2 filed on 2022 May 29; all applications are incorporated by reference herein in their entirety.

### BACKGROUND

The invention relates to a method for generating a composite circular image or circular ring image on a screen with image data from a rotating camera, and a deletion system therefor.

In order to thermographically monitor a large room from its center, a fisheye lens with an angle of view of at least 180° would be advantageous for an infrared camera. However, such a lens cannot be used in conjunction with an infrared camera to take thermographic images, as it creates strong distortions in the edge area of the image, which lead to measurement errors in the temperature.

Such a room to be monitored with a camera within the meaning of the invention can be, for example, a storage facility or production facility or the like, both outdoors and indoors. For fire detection, or early fire detection, such rooms comprise predominantly automatic extinguishing systems having at least one camera, which is usually arranged at a top side, for example on a room ceiling or on a mast or the like, and is pivoted over the area to be monitored. If a fire source, glowing embers, or an area with an unusually high temperature for the material monitored is detected, indicating that a fire may be starting in this location of higher temperature (also called hotspot hereinafter) in a deeper area below the surface that can be monitored thermographically, the controller directs an extinguishing agent sprayer at this fire source and opens a valve so that the extinguishing agent flows out at a relatively high pressure and in a relatively large quantity. Due to inaccuracies in the detection of the fire source and in the aiming of the extinguishing agent sprayer, the extinguishing agent sprayer is often pivoted vertically and/or horizontally in order to extinguish the fire source.

A method for displaying images from a movable surveillance camera on a monitor is known from US 2013/0 021 433 A1. Furthermore, WO 97/25 628 A1 discloses a camera system for optical monitoring of large areas. Finally, DE 20 2010 000 060 U1 describes an extinguishing system for fighting fire sources, comprising an infrared camera.

### SUMMARY

The invention relates to a method for generating a composite circular image (12) or circular ring image (13) on a screen (7) using image data from a rotating camera (2) with a certain orientation to the axis of rotation (33), in which method the image data are processed at an image-processing device (10), the camera (2) supplying a rectangular image (14) which is longitudinally delimited by a start line (15) and an end line (16), and the image (14) being modified in such a way—that the start line (15) forms a circular image center point (22) and the end line (16) forms an outer radius of a circular segment image (24) when the camera (2) is oriented in such a way that the start line (15) intersects the axis of rotation (33), a plurality of circular segment images (24) being sequentially assembled to produce a circular image (12), or—that the start line (15) forms an inner radius and the end line forms an outer radius of a circular sector image (35) when the camera (2) is oriented in such a way that the start line (15) is offset by a positive angle to the axis of rotation (33), a plurality of circular sector images (35) being sequentially assembled to produce a circular ring image (13), —wherein the image-processing device (10) concentrically aligns at least one generated circular image (12) with at least one generated circular ring image (13) and displays images (14), that are captured successively by means of the camera (2), in combined fashion on the screen (7).

### DETAILED DESCRIPTION

The invention is based on the object of creating a method of the type mentioned at the outset which provides a continuous informative display of the monitored space on a screen

According to the invention, the object is achieved by the features of the independent claim.

The dependent claims represent advantageous embodiments of the invention.

In a method for generating a composite circular image or circular ring image on a screen with image data from a rotating camera with a specific alignment to the axis of rotation, the image data are processed on an image-processing device, wherein the camera provides a rectangular image which is bounded on the longitudinal side by a start line and an end line, and the image is changed in such a way
that the start line forms a circular image center point and the end line forms an outer radius of a circular segment image when the camera is aligned in such a way that the start line intersects the axis of rotation, a plurality of circular segment images being temporally sequentially assembled to produce a circular image, or
that the start line forms an inner radius and the end line forms an outer radius of a circular sector image when the camera is aligned in such a way that the start line is offset by a positive angle to the axis of rotation, a plurality of circular sector images being temporally sequentially assembled to produce a circular ring image,
wherein the image-processing device aligns at least one generated circular image and at least one generated circular ring image concentrically to one another and displays images, captured successively by means of the camera, in combined fashion on the screen.

Self-evidently, digital cameras which also send digital images, i.e. image data, to the image-processing device of the computer for further processing and analysis, are used in connection with the method according to the invention. The computer can be a stationary computer, a virtual computer, a so-called tablet computer, a laptop, or the like.

The circular image or circular annular image can encompass any angle and, as will be apparent to a person skilled in the art, can be any size smaller than 360°. In particular, the circular images or circular annular images can be adapted to an object to be monitored, for example a corner region of a building or storage area. Then, for example, the camera can oscillate by an angle of less than 360° and a corresponding circular image or circular annular image is composed and displayed.

The camera used within the framework of the invention can be an infrared camera (IR camera) or a video camera, the images of which are analyzed on the image-processing device with regard to features that indicate smoke or fire.

The generated circular image or circular ring image is relatively clear and allows observation of a relatively large space without the distortions caused by the lens, where the wider the image, the greater the distortions are.

In order to obtain detailed and informative images both in the center, i.e. below the camera's axis of rotation, and further away in a relatively large space to be monitored by the camera, the image-processing device combines at least one generated circular image with at least one generated circular ring image, which are aligned concentrically to one another and captured one after the other by the camera. Self-evidently, due to panning of the camera that may be necessary, the circular image is a time-offset representation of the at least one circular ring image, which with its inner diameter can connect almost seamlessly to the outer diameter of the circular image. Self-evidently, a plurality of circular ring images can be combined with each other.

Self-evidently, circular images and circular ring images smaller than 360° can also be generated and displayed here, wherein the size can be determined by rotating the camera or during image generation, in particular in order to exclude, for example, a corner of a building or a sector that is not to be observed.

In order to avoid undesirable distortions of the image which is constantly being updated on the screen and can be displayed in real time, according to a further development a central portion of the rectangular image extending from the start line to the end line is selected and processed by the image-processing device for processing to produce the circular segment image or the circular sector image. In this case, a portion of the image with a width of, for example, 40 thermal pixels can be taken relatively precisely from the center of the image, since this is where the least image distortion occurs. A relatively narrow strip of the image is selected for processing and analysis, since as the width of the image increases, the fisheye effect on the image becomes more pronounced and images can no longer be joined together without distortion. Therefore, in the process the individual images, in particular IR thermal images, are not arranged one after the other; rather, small portions of the IR thermal image are captured and arranged one after the other along with their position as the camera rotates.

In an embodiment, the height dimension of the image forms a radius of the circular segment images or a width of the circular sector image. The rectangular image recorded and evaluated by the camera is converted into a thermographic circular image or annular ring image, wherein the lower row of pixels, referred to here as the start line, is converted into a central pixel in a circular image and into a small diameter of the circular ring in a circular ring image.

The image-processing device expediently converts the image into a thermographic image and evaluates it according to thermal limit values stored in a storage device. It is not necessary to permanently display all details of the thermographic image. The representation of certain hotspots, i.e. heat spots that have a temperature above stored limit temperatures, on a uniform background is very clear, wherein a representation of the individual circular segment image or circular sector image in real time is only indicated and the detailed representation takes place after entering a corresponding command on the image-processing device. If, for example, an operator taps on the location of a hotspot displayed on a touchscreen, the detailed image is then displayed and it is possible to see what caused the hotspot. Limit temperatures can be stored, for example, for pre-alarms and/or for alarms that can be displayed in different ways.

Preferably, the image-processing device calculates polar coordinates of thermal pixels when converting the image into the thermographic image. The polar coordinates can be used, for example, to control an extinguishing agent sprayer. The polar coordinates can be determined easily if the position of the camera in the monitored room and its rotational position for the corresponding data processing are available on a computer control system comprising the image-processing device. Regarding the rotational position of the camera, which either rotates or oscillates, data from a stepper motor or a position sensor can be used for evaluation.

The method is used, for example, in an extinguishing system with
at least one extinguishing agent sprayer which is connected to an extinguishing agent line rotatable about a mounting axis by means of at least one motor and pivotable about a pivot axis in order to be supplied with extinguishing agent,
at least one camera that is able to be rotated at least about a mounting axis by means of at least one motor,
an electronic controller that comprises at least one storage device in which at least geometric basic data of the relevant area and/or data of the extinguishing agent sprayer are stored so as to be capable of being read, and a computer module for data processing, as well as an image-processing device that operates according to the method explained above,
an input device, connected to the controller, for inputting data and/or for controlling the extinguishing agent sprayer and the camera, and
a screen, connected to the controller, for displaying images from the camera prepared by the image-processing device.

The by the image-processing device to produce a circular image or a circular ring image or a combination of the circular image with at least one circular ring image aligned concentrically to it is displayed on the screen, and in the case of thermal evaluation, where necessary areas with a temperature that exceeds stored limit values are displayed as a pre-alarm or alarm. An alarm indicates a fire and the extinguishing agent sprayer can be positioned based on the data available at the controller in such a way that dispensed extinguishing agent hits the location of the fire. The accuracy is increased if the camera and/or the extinguishing agent sprayer are assigned a laser connected to the controller that can carry out a distance measurement.

It is understood that the features mentioned above and still to be explained below can be used not only in the respectively specified combination but also in other combinations. The scope of the invention is defined only by the claims.

The invention is explained in more detail below on the basis of embodiments and with reference to the associated drawings.

### BRIEF DESCRIPTION OF THE DRAWINGS

In the drawings:

FIG. 1 is a schematic representation of an arrangement for carrying out the method according to the invention,

FIG. 2 is a schematic representation of an assembled camera image,

FIG. 3 is a representation of a camera image,

FIG. 4 is a partial representation of a camera image detail according to FIG. 3,

FIG. 5 is a schematic representation of the transformed camera image detail according to FIG. 4,

FIG. 6 is a schematic representation of a generated circular image,

FIG. 7 is a second schematic representation of the arrangement according to FIG. 1,

FIG. 8 is a schematic representation of a generated circular ring image,

FIG. 9 is a schematic representation of a circular image composed of a plurality of circular ring images and one circular image,

FIG. 10 is a third schematic representation of the arrangement according to FIG. 1,

FIG. 11 is a fourth schematic representation of the arrangement according to FIG. 1,

FIG. 12 is a representation of a thermal circular image, and

FIG. 13 is a schematic representation of a room to be monitored with an extinguishing system according to the invention.

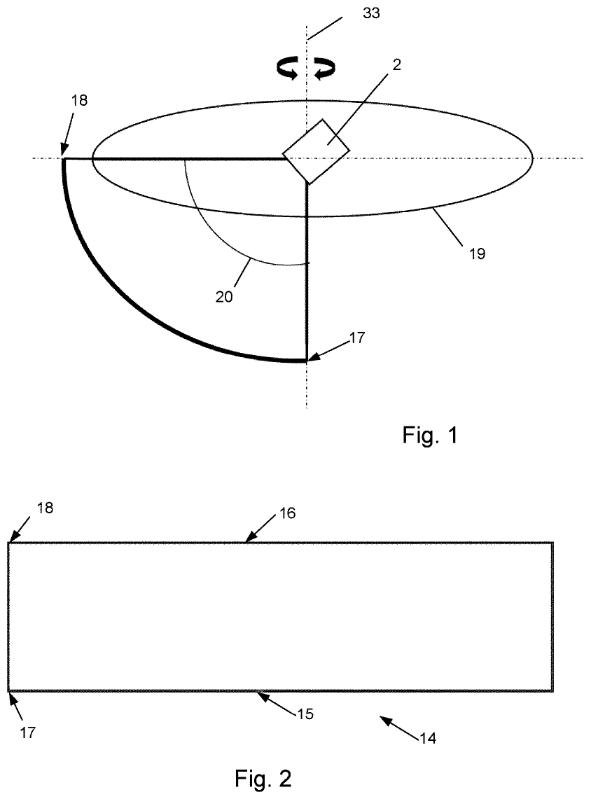

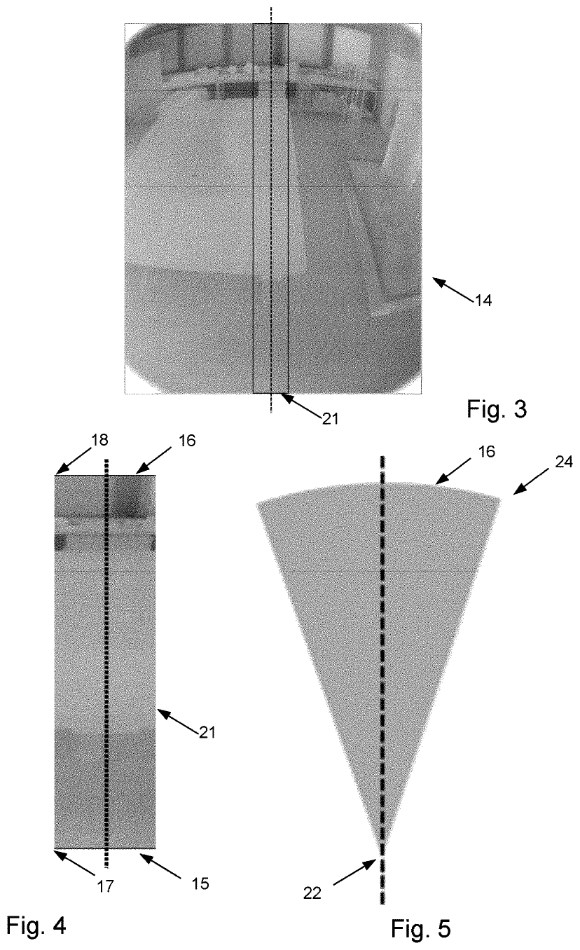

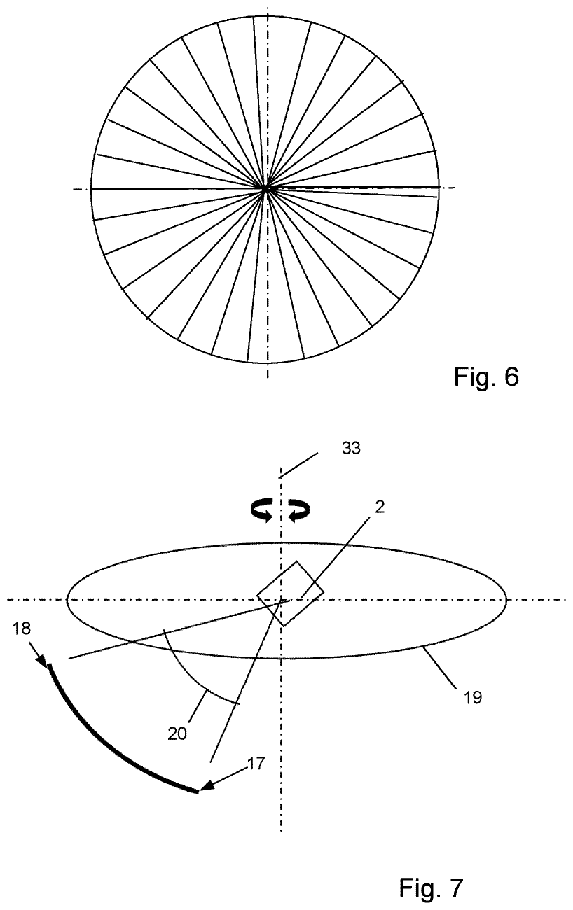

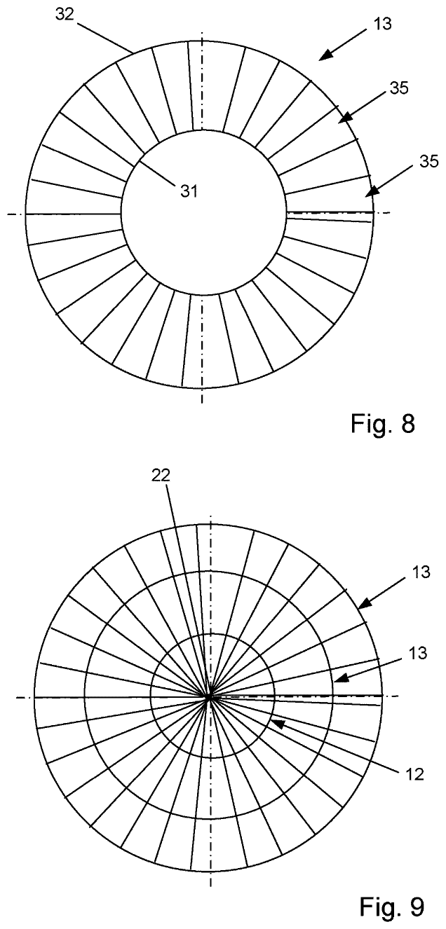

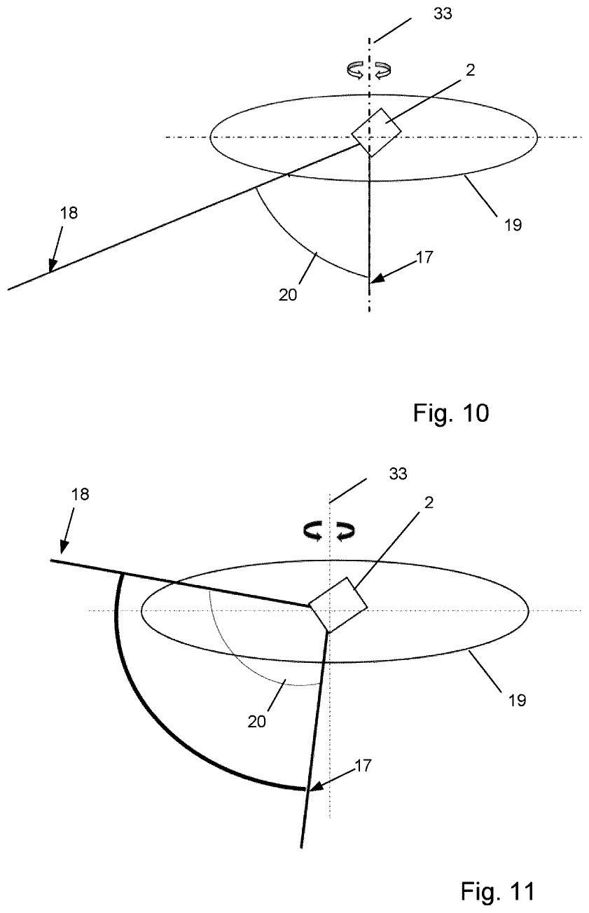

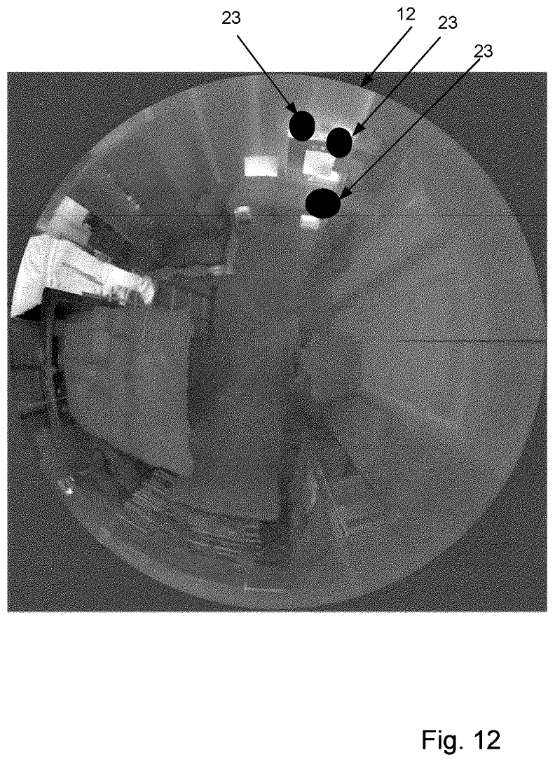

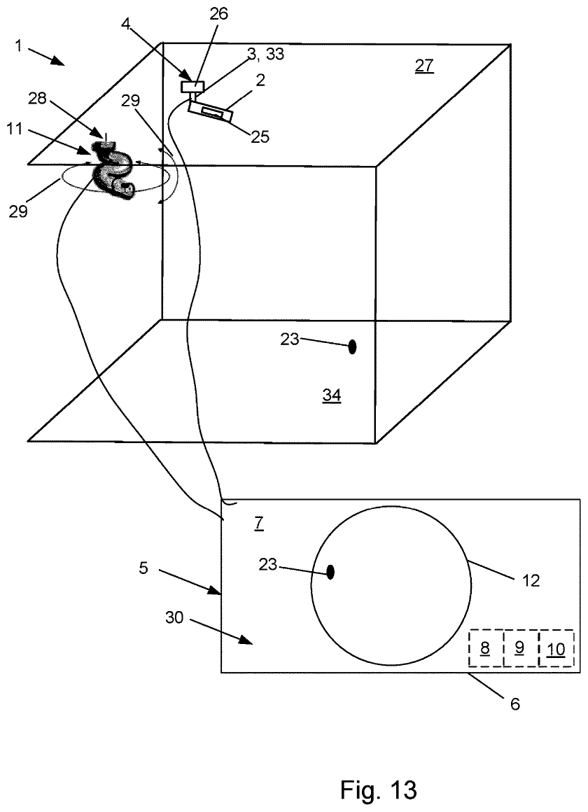

### DETAILED DESCRIPTION OF THE PREFERRED EMBODIMENTS

A digital camera 2, which is designed as a video camera or infrared camera, is installed on a ceiling 27 of a room 1 to be monitored or on a mast or support or the like. Self-evidently, the room 1 can also be an outdoor storage area or any other area, for example a forest area or the like. The camera 2 is mounted on a mounting axis 3 so that it can rotate about it. Thus, the mounting axis 3 is an axis of rotation 33. The camera 2 can rotate by up to 360°, for example by oscillating, by means of an associated motor 4. The camera 2 has for example an image resolution of 640×480 pixels with an aperture angle of 90°×67.5°. It is apparent to a person skilled in the art that cameras 2 with modified resolutions and/or aperture angles can also be used.

The camera 2 and the motor 4 assigned to the camera 2 are coupled to an electronic controller 5, which in the present case is designed as a tablet computer 6 with a screen 7 designed as a touchscreen, wherein the controller 5 can of course also comprise a stationary or virtual computer. At least one memory device 8 for readable storage of data, a computer module 9 and an image-processing device 10 for data processing are installed on the controller 5.

The basic geometric data of the room 1, which are measured on site as actual data, are stored in the storage device 8 of the electronic controller 5. These basic geometric data of the room 1 describe the floor area, i.e. the dimensions of the floor 34 and the height of the room 1. Furthermore, the coordinates at which the axis of rotation 33 of the camera 2 and an extinguishing agent sprayer 11 are attached are stored. In addition, standard sprayer curves determined by the manufacturer, which describe the spraying distances of the extinguishing agent under a particular pressure and specified extinguishing agent sprayer settings, as well as various software, can be stored.

The software and the image-processing device 10 ensure detection of a hotspot 23, i.e. a warm spot with an actual temperature above a limit temperature, which is stored for a pre-alarm and/or an alarm in the event of a fire.

In order to generate a representation of the monitored room 1 on the screen 7 that is easy for an observer or operator to grasp, a circular image 12 or a circular ring image 13 or a circular image 12 consisting of at least one circular image 12 and/or at least one circular ring image 13 is generated by the image-processing device 10, in which in particular the disadvantages of a rectangular image that the camera 2 supplies, for example with a fisheye lens, are avoided.

For the present aperture angle 20 of 90°×67.5°, the rectangular image of the camera 2 has an image resolution of 640×480 pixels and begins at the bottom with a start line 15 and ends at the top with the end line 16. The camera 2 is mounted on the mounting axis 3, or axis of rotation 33, in such a way that it is pivoted by 45° to the mounting axis 3 at the opening angle 20 of 90°, so that the start line 15 is aligned with the mounting axis 3 or intersects with the extension of it, and a start corner pixel 17 is almost stationary. An end corner pixel 18 of the end line 16 describes a circular path 19 when the camera 2 rotates.

If the full resolution of camera 2 is assigned to the 360° circular path 19, the result is: 360° circumference/67.5° aperture angle=5.33 camera images put together.

Therefore:

5.33×480 thermal pixels per 67.5° opening angle results in a circular resolution of approx. 2,558 thermal pixels for 360° resolution.

When rotated by 360°, a thermographic rectangular image 14 is created, which is limited at the lower side by the start line 15 and at the upper side by the end line 16, and has a height of 640 thermal pixels and a length of 2,558 thermal pixels, wherein the start corner pixel 17 in the arrangement described above almost always points to the same location point below the mounting axis 3, which acts as the axis of rotation. In order to be able to visually interpret this rectangular image 14, small portions of the IR thermal image 14 are recorded during rotation of the camera 2 along with their position, and are arranged one after the other. The width of these portions varies. This depends on the processing speed of the computer module 9 of the controller 5 in which these portions are joined together, and on the rotational speed of the motor 4. The narrower the portions are, the less distorted the overall image will be, but the more computing power the system will require.

To simulate a wide-angle lens of approximately 180° of an IR camera 2, a central portion 21 of the image 14, as a portion with a width of e.g. 40 thermal pixels, is taken as precisely as possible from the center of the image, since the smallest image distortions are present in the center of the image, because the wider the image 14 is, the greater the fisheye effect is in a recording, and the partial images can then no longer be joined together without distortion.

The central portion 21 of the image 14 now represents the image 14 which, in the arrangement described above, has to be converted into a thermographic circular image 12, so that the lower starting line 15 is converted into a central circular image center point 22, where the height of the center portion 21 of the thermal image 14 corresponds to the radius of a circular segment image 24. Each line of the central portion 21 has to be converted into a circular segment line. The closer one comes to the center of the circular image 22, the fewer thermal pixels fit into the corresponding line of the circular segment image 24. Therefore, thermal pixel groups must be formed that consist of a plurality of thermal pixels located next to each other. The closer one comes to the center, i.e. the circular image center point 22 of the circular image 12, the more thermal pixels a thermal pixel group contains.

Averaging the individual thermal pixels of a thermal pixel group leads to a smoothing of the maximum temperatures. Therefore, when a thermal pixel group is combined into a new thermal pixel, the temperature value of the hottest thermal pixel in the group is always used. The use of the maximum value when summarizing a thermal pixel group is particularly advantageous when the design described above is used for fire monitoring and displaying a fire source, i.e. a hotspot 23.

At the same time, the polar coordinates of the thermal pixels are also calculated in order to be able to immediately position an extinguishing agent sprayer 11 onto the fire source, the hotspot 23, in the event of a fire alarm. When calculating the polar coordinates, data from a position sensor 26 on the mounting axis 3 can be determined and processed at the controller 5. The alignment of the extinguishing agent sprayer 11 can be simplified to take into account the trajectory parabola of the extinguishing agent applied by a laser 24 assigned to the camera 2, which is designed to measure distances and is connected to the control system 5.

To display a circular image 12 on the screen 7, a plurality of circular segment images 24 are arranged one after the other and are also overwritten as the camera 2 continues to rotate.

If a camera 2 with an aperture angle 20 smaller than 90° is selected, for example, to monitor a partial area of the room 1, then the start corner pixel 17 is not aligned with the mounting axis 3 and describes a circular path that is concentric with the circular path 19 of the end corner pixel 18.

Here too, a central portion 21 is extracted from the image 4 and converted into a thermographic circular annular image 13, so that the lower start line 15 is converted to an inner diameter 31 and the upper end line 16 is converted to an outer diameter 32 of a circular sector image 35, wherein the height of the central portion 21 of the thermal image 14 corresponds to the difference between the outer diameter 32 and the inner diameter 31 of the circular sector image 35. The circular sector images 35 resulting from the rotation of the camera 2 are continuously combined to form the circular annular image 13.

Self-evidently, circular images 12 and/or circular annular images 13 or corresponding combinations with any angle smaller than 360° can also be generated and displayed, in particular depending on the angle of rotation of the camera 2 or controlled by the image-processing device 10.

To change the diameter or area to be monitored in the room 1, a camera 2 with an aperture angle 20 smaller than 90° is selected and aligned such that the start corner pixel 17 is aligned with the mounting axis 3 and the end corner pixel 18 describes a circular path that is aligned concentrically with the circular path 19 and has a diameter that is different from it. As already described, a circular image 12 is generated and displayed.

If an area above the mounting of the camera 2 in the room 1, for example a ceiling 27, is to be monitored, then a camera 2 with an aperture angle 20 of 90° can be selected and aligned such that the start corner pixel 17 is not in alignment with the mounting axis 3 and the end corner pixel 18 describes a circular path that is aligned concentrically to the circular path 19 and has a different diameter compared to it. As already described, a circular annular image 12 is generated and displayed.

It is apparent to a person skilled in the art that with the camera 2, by pivoting it relative to the mounting axis 3, for example a circular image 12 and a plurality of circular annular images 13, or a plurality of circular annular images 13 without a central circular image 12 with different diameters, can be generated one after the other and aligned concentrically to one another in a common representation in order to be able to capture a relatively large space 1, both centrally and in peripheral edge regions.

The room 1 to be monitored is, for example, a storage room for combustible material, such as tires, garbage, but also motor vehicles, plastics, or the like. The room 1 can be defined by the dimensions of its base area and its height in a known manner.

In order to monitor the room 1 for the occurrence of a fire and, if necessary, to start an automatic extinguishing of the fire, the extinguishing system is installed, which substantially comprises the camera 2 designed as a thermal imaging camera and the extinguishing agent sprayer 11, which can also be referred to as an extinguishing monitor or extinguishing sprayer. The camera 2 and the extinguishing agent sprayer 11 are mounted at specific positions on the ceiling 27 of the room 1 in such a way that the mounting axis 3 of the camera 2 is aligned parallel to a mounting axis 28 of the extinguishing agent thrower 11.

The extinguishing agent sprayer 11 can be pivoted about two axes, as indicated by the arrows 29 assigned to the extinguishing agent sprayer 11, namely about its mounting axis 28 and an axis aligned at an angle to it. The extinguishing agent sprayer 11 is connected to pipe or hose lines for the extinguishing agent. Furthermore, the extinguishing agent sprayer 11 is coupled to the electronic controller 5, which, in a design as a tablet computer 6 with a touchscreen 30, serves both as an input unit and for displaying the generated circular images 12 and circular ring images 13.

If a hotspot 23 is displayed on the touchscreen 30 within the circular image 12 or circular ring image 13, then the image portion with the hotspot 23 can be displayed and an extinguishing agent sprayer 11 can be oriented by simply tapping the hotspot 23 on the touchscreen 30. As an alternative to the control via touchscreen 30, a joystick can also be provided as an input device on a computer with an associated screen.

The position of the fire source detected by the camera 2 can be described with a relatively low computational effort using the polar coordinates determined by the image-processing device 10 and, if applicable, the distance data determined by the laser 25, and the extinguishing agent sprayer 11 can be tracked relatively precisely, since in particular the fastening axes 3, 28 on both sides are aligned parallel to one another, so that deviations or errors of lesser significance arise due to the different mounting points. However, the error is usually so small that the fire at this point can also be hit by the extinguishing agent in order to extinguish it.

LIST OF REFERENCE NUMERALS

| | |
|---|---|
| 1. | Room |
| 2. | Camera |
| 3. | Mounting axis of 2 |
| 4. | Motor |
| 5. | Controller |
| 6. | Tablet computer |
| 7. | Screen |
| 8. | Storage device |
| 9. | Computer module |
| 10. | Image-processing device |
| 11. | Extinguishing agent sprayer |
| 12. | Circular image |
| 13. | Circular annular image |
| 14. | Image |
| 15. | Start line |
| 16. | End line |
| 17. | Start corner pixel |
| 18. | End corner pixel |
| 19. | Circular path |
| 20. | Opening angle |
| 21. | Middle portion |
| 22. | Center of the circular image |
| 23. | Hotspot |
| 24. | Circular segment image |
| 25. | Laser |
| 26. | Position sensor |
| 27. | Ceiling |
| 28. | Mounting axis of 11 |
| 29. | Arrows |
| 30. | Touchscreen |
| 31. | Inner diameter |
| 32. | Outer diameter |
| 33. | Axis of rotation |
| 34. | Floor |
| 35. | Circle sector image |

1. A method for generating a composite circular image (12) or circular ring image (13) on a screen (7) with image data from a rotating camera (2) with a specific alignment to the axis of rotation (33), which are processed on an image-processing device (10), wherein the camera (2) provides a rectangular image (14) which is bounded on the longitudinal side by a start line (15) and an end line (16), and the image (14) is changed in such a way
that the start line (15) forms a circular image center point (22) and the end line (16) forms an outer radius of a circular segment image (24) when the camera (2) is aligned in such a way that the start line (15) intersects the axis of rotation (33), wherein a plurality of circular segment images (24) are temporally sequentially combined to produce a circular image (12), or
that the start line (15) forms an inner radius and the end line forms an outer radius of a circular sector image (35) when the camera (2) is aligned in such a way that the start line (15) is offset by a positive angle to the axis of rotation (33), wherein a plurality of circular sector images (35) are temporally sequentially combined to produce a circular ring image (13),
wherein the image-processing device (10) aligns at least one generated circular image (12) with at least one generated circular ring image (13) concentrically to one another and displays images (14), captured successively by means of the camera (2), in combined fashion on the screen (7).

2. The method according to claim 1, characterized in that a center portion (21) of the rectangular image (14) extending from the start line (15) to the end line (16) is selected and processed by the image-processing device (10) for processing to produce the circular segment image (24) or the circular sector image (35).

3. The method according to claim 1, characterized in that the height dimension of the image (14) forms a radius of the circular segment image (24) or a width of the circular sector image (35).

4. The method according to claim 1, characterized in that the image-processing device (10) converts the image (14) into a thermographic image and evaluates it according to thermal limit values stored on a storage device (8).

5. The method according to claim 1, characterized in that the image-processing device (10) calculates polar coordinates of thermal pixels when converting the image (14) into the circular segment image (24) or the circular sector image (35).

6. The method according to claim 1, characterized in that the image-processing device (10) displays a plurality of generated circular ring images (13), concentrically aligned with one another and captured successively by means of the camera, in combined fashion on the screen (7).

7. A camera (2) for use in a method according to claim 1, characterized in that it has an image resolution of 640×480 pixels with an opening angle (20) of 90°× 67.5°.

8. An extinguishing system with
at least one extinguishing agent sprayer (11) that is able to be rotated about a mounting axis (28) by means of at least one motor and is connected to an extinguishing agent line in order to be supplied with extinguishing agent,
at least one camera (2) that is able to be rotated at least about a mounting axis (3) by means of at least one motor (4),
an electronic controller (5) that comprises at least one storage device (8) in which at least geometric basic data of the relevant area and/or data of the extinguishing agent sprayer (11) are stored so as to be capable of being read, and a computer module (9) for data processing, as well as an image-processing device (10) that operates according to the method according to claim 1,
an input device, connected to the controller (5), for inputting data and/or for controlling the extinguishing agent sprayer (11) and the camera (2), and
a screen (7) connected to the controller (5) for displaying circular images (12) and/or circular ring images (13) of the image-processing device (10).
